(19) United States
(12) Patent Application Publication
(10) Pub. No.: US 2016/0321985 A1
(43) Pub. Date: Nov. 3, 2016

(54) REPLACEABLE DISPLAY SYSTEM

(71) Applicant: E Ink Holdings Inc., Hsinchu (TW)

(72) Inventors: Su-Cheng LIU, HSINCHU (TW); Tien-Haw PENG, HSINCHU (TW)

(21) Appl. No.: 15/207,513

(22) Filed: Jul. 12, 2016

Related U.S. Application Data
(63) Continuation of application No. 13/659,979, filed on Oct. 25, 2012.
(60) Provisional application No. 61/606,478, filed on Mar. 5, 2012.

(30) Foreign Application Priority Data
Aug. 31, 2012 (TW) 101131780

(51) Int. Cl. G09G 3/20; G06F 1/16; G09G 3/36; G09G 3/3208; G09F 9/37; G09G 3/34

(52) U.S. Cl. CPC G09G 3/2096; G09F 9/372; G09G 3/344; G09G 3/36; G09G 3/3208; G09G 3/2007; G06F 1/1601; G09G 2300/08; G09G 2330/02

(57) ABSTRACT

A replaceable display system includes a display back plate having a driving array substrate, a front panel laminate, and a display region, a controller, and an image film. The front panel laminate is located on the driving array substrate and includes a display medium layer. The display region is located on the front panel laminate and includes a plurality of sub-display regions. Each of the sub-display regions is displayed as a bright face or a dark face by the display medium layer. The controller is electrically connected to the display back plate to control each of the sub-display regions to display as the bright face or the dark face. The image film is detachably located on the display region and includes a light transmissive pattern portion aligned with at least one of the sub-display regions.

### RELATED APPLICATIONS

This application is a continuation of U.S. application Ser. No. 13/659,979, filed Oct. 25, 2012, which claims priority to U.S. Provisional Application Ser. No. 61/606,478, filed Mar. 5, 2012, and Taiwan Application Serial Number 101131780, filed Aug. 31, 2012, all of which are herein incorporated by reference.

### BACKGROUND

1. Technical Field

The present disclosure relates to a replaceable display system, and more particularly to a replaceable display system having an image film for displaying a pattern.

2. Description of Related Art

Generally, in electrophoretic display technology a display medium (or referred to as electronic ink) is mainly formed by an electrophoresis buffer and white charged particles doped in the electrophoresis buffer. The display medium is sandwiched between an upper and a lower protection layers to form a display medium layer. The white charged particles are driven to move by applying a voltage, so as to make each pixel of an electrophoretic display present a color of black, white or gray level.

The electrophoretic display often takes an external light source and reflects the external light in displaying. Through the movement of the white charged particles in the electrophoretic buffer driven by applying a voltage, each pixel of the display is able to present the required gray level. Moreover, to expand the application scope of the electrophoretic display, a color filter film may be arranged on the display medium layer, and secured thereon by an adhesion layer. Accordingly, the incident light passes through the color filter film, after being reflected by the white charged particles in the display medium, and present colors.

As to the applications of displaying posters or black-and-white images, the displaying content is often presented in the display through an electronic image file. However, the display content needs to be constantly changed by manpower which requires a certain management cost. Further, if the display is the color electrophoretic display, the hardware cost is increased due to the additional requirement of the color filter film.

On the other hand, in a shopping mall, a poster is often made of papers. Though the paper poster is convenient to be manually removed or changed, the poster is normally damaged and cannot be reused after the removal from the wall.

### SUMMARY

An aspect of the present invention is to provide a replaceable display system.

In an embodiment of the present invention, a replaceable display system includes a display back plate, a controller, and an image film. The display back plate includes a driving array substrate, a front panel laminate, and a display region. The front panel laminate is located on the driving array substrate and includes a transparent substrate and a display medium layer sandwiched between the driving array substrate and the transparent substrate. The display region is located on the front panel laminate and includes a plurality of sub-display regions. Each of the sub-display regions is displayed as a bright face or a dark face by the display medium layer. The controller is electrically connected to the display back plate to control each of the sub-display regions to display as the bright face or the dark face. The image film is detachably located on the display region and includes a light transmissive pattern portion aligned with at least one of the sub-display regions. When one of the sub-display regions aligned with the light-transmissive pattern portion displays as the bright face, a pattern of the light-transmissive pattern portion is displayed by one of the sub-display regions.

In an embodiment of the present invention, the replaceable display system further includes an adhesive layer located between the image film and the display region.

In an embodiment of the present invention, the adhesion force formed between the adhesive layer and the image film is larger than another adhesion force formed between the adhesive layer and the display region.

In an embodiment of the present invention, the driving array substrate includes a plurality of pixel units. Each of the pixel units includes a thin film transistor and a pixel electrode. The display medium layer includes a plurality of microencapsules. The front panel laminate further includes a common electrode located on the transparent substrate and facing the pixel electrodes. The microencapsules are located between the common electrode and the pixel electrodes.

In an embodiment of the present invention, each of the microencapsules includes a plurality of bright electrophoretic particles and dark electrophoretic particles to display one of the sub-display regions as the bright face or the dark face.

In an embodiment of the present invention, the display back plate includes a bi-stable display module, such as an electrophoretic display module or a cholesteric liquid crystal display module, but not limited in this regard.

In an embodiment of the present invention, the display back plate includes a spontaneous light emitting display module, such as an organic light emitting diode display module or a light emitting diode display module, but not limited in this regard.

In an embodiment of the present invention, the replaceable display system including the display back plate which includes the spontaneous light emitting display module further includes a diffusion sheet located between the image film and one of the sub-display regions which is aligned with the light-transmissive pattern portion.

In an embodiment of the present invention, when one of the sub-display regions covered by the image film displays alternately dynamic variation as the bright face and the dark face, the pattern of the light-transmissive pattern portion correspondingly displays alternately bright and dark variation.

In an embodiment of the present invention, shapes of the sub-display regions comprising rectangular, square, hexagonal, polygon, circular, or combinations thereof.

In an embodiment of the present invention, the display back plate further includes a non-image display region adjacent to the display region to display a text.

In an embodiment of the present invention, the replaceable display system further includes a storage device electrically connected to the controller to save a driving program code of the display back plate.

In an embodiment of the present invention, the storage device includes a memory card slot, a memory chip, a system-on-chip memory, or an embedded memory.

In an embodiment of the present invention, the replaceable display system further includes a signal interface electrically connected to the controller to receive an inputting control signal.

In an embodiment of the present invention, the signal interface includes a universal serial bus.

In an embodiment of the present invention, the replaceable display system further includes a power supply module electrically connected to the controller to provide the display back plate electricity.

In an embodiment of the present invention, the power supply module includes a photoelectric conversion module, a battery, or a power interface.

In an embodiment of the present invention, the replaceable display system further includes a housing case and a stand. The housing case accommodates the display back plate and the image film and includes an opening aligned with the display region. The stand includes a groove to couple to the housing case.

In the aforementioned embodiments of the present invention, since the image film is detachably located on the display region, and the light transmissive pattern portion of the image film is displayed by the sub-display regions which display as the bright faces, the replaceable display system can display different patterns by changing the image film on the display region. That is to say, the display back plate does not directly display an image, which is only as a back reflection face or a back light source of the light transmissive pattern portion, such that a light is through the light transmissive pattern portion to display the image. Therefore, the number of the sub-display regions of the display back plate and the number of the pixel units of the driving array substrate can be reduced, such that the display back plate can have low resolution to save the manufacturing cost.

When another image film including different light transmissive pattern portion replaces the original image film, the sub-display regions under the light transmissive pattern portion can be displayed as the bright faces by the controller, such that the replaceable display system displays a different pattern. Compared with a traditional poster, the replaceable display system can display different patterns by the different image films. Furthermore, the image film is not easily damaged when being detached, and which can be reused, thereby saving a waste of paper material and protecting the environment.

### BRIEF DESCRIPTION OF THE DRAWINGS

FIG. 1 is a perspective view of a replaceable display system according to an embodiment of the present invention;

FIG. 2 is an exploded view of the replaceable display system shown in FIG. 1;

FIG. 3 is a cross-sectional view of the replaceable display system taken along line 3-3′ shown in FIG. 1;

FIG. 4 is front view of the replaceable display system shown in FIG. 1;

FIG. 5 is a schematic view of a light transmissive pattern portion shown in FIG. 4 when displayed;

FIG. 6 is a cross-sectional view of the light transmissive pattern portion shown in FIG. 4 when displayed;

FIG. 7 is a schematic view of a light transmissive pattern of a replaceable display system when displayed according to an embodiment of the present invention;

FIG. 8 is a schematic view of a replaceable display system according to an embodiment of the present invention;

FIG. 9 is a block diagram of a replaceable display system according to an embodiment of the present invention;

FIG. 10 is a front view of a replaceable display system according to an embodiment of the present invention;

FIG. 11 is a front view of a replaceable display system according to an embodiment of the present invention;

FIG. 12 is a top view of the replaceable display system shown in FIG. 11;

FIG. 13 is a front view of a replaceable display system according to an embodiment of the present invention; and

FIG. 14 is a block diagram of a replaceable display system according to an embodiment of the present invention.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

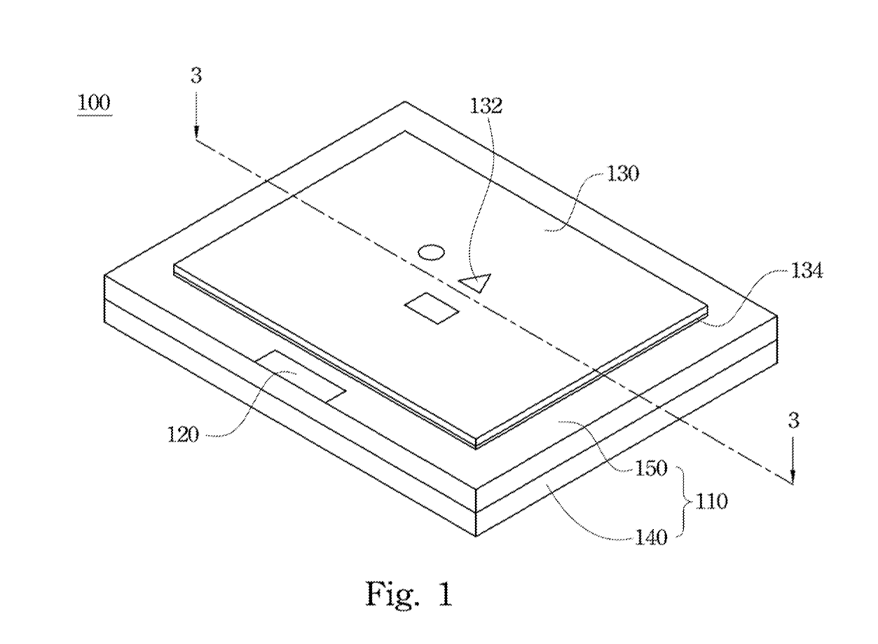

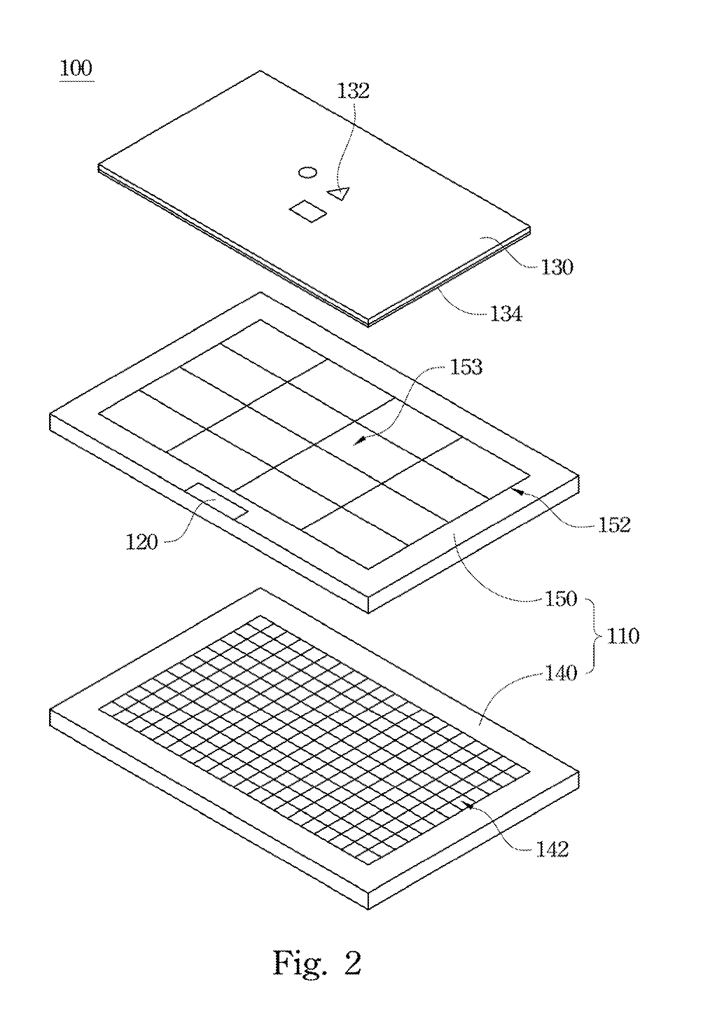

FIG. 1 is a perspective view of a replaceable display system 100 according to an embodiment of the present invention. FIG. 2 is an exploded view of the replaceable display system 100 shown in FIG. 1. As shown in FIG. 1 and FIG. 2, the replaceable display system 100 includes a display back plate 110, a controller 120, and an image film 130. The display back plate 110 includes a driving array substrate 140, a front panel laminate 150, and a display region 152. The display region 152 is located on the front panel laminate 150 and includes a plurality of sub-display regions 153. The controller 120 is electrically connected to the display back plate 110 to control each of the sub-display regions 153 to display as the bright face or the dark face. The image film 130 is detachably located on the display region 152 and includes a light transmissive pattern portion 132. The light transmissive pattern portion 132 is aligned with at least one of the sub-display regions 153. When the sub-display region 153 aligned with the light-transmissive pattern portion 132 displays as the bright face, a pattern of the light-transmissive pattern portion 132 can be displayed. In this embodiment, the controller 120 is placed on the front panel laminate 150, but the present invention is not limited in this regard.

The display back plate 110 may be a bi-stable display module, such as an electrophoretic display (EPD) module or a cholesteric liquid crystal display (ChLCD) module, and which may also be a spontaneous light emitting display module, such as an organic light emitting diode (OLED) display module or a light emitting diode (LED) display module in accordance with designers' requirement, but not limited in this regard. When the display back plate 110 is the bi-stable display module, such as the electrophoretic display module or the cholesteric liquid crystal display module, the sub-display region 153 aligned with the light-transmissive pattern portion 132 can reflect an incident light and display as the bright face. When the display back plate 110 is the spontaneous light emitting display module, such as the organic light emitting diode display module or the light emitting diode display module, the sub-display region 153 aligned with the light-transmissive pattern portion 132 can directly emit a light as the bright face.

Moreover, the replaceable display system 100 further includes an adhesive layer 134 located between the image film 130 and the display region 152, and the adhesion force formed between the adhesive layer 134 and the image film 130 is larger than another adhesion force formed between the adhesive layer 134 and the display region 152. The adhesive layer 134 may be a double side adhesive tape, such as a double side adhesive tape 8010P of 3M Corporation®. The image film 130 may be made of a material that includes plastic (e.g., PET), soft materials, or hard materials. The image film 130 is light permeable, which can be repeatedly adhered or detached on the display region 152 of the display back plate 110 and is not easily damaged. The light-transmissive pattern portion 132 may include a colored dye. When a light is through the light-transmissive pattern portion 132, the light-transmissive pattern portion 132 can display a colored pattern. The image film 130 may be used to perform content of a poster, and which can be formed by printing a film. Therefore, the colored, monochrome, or black and white light-transmissive pattern portion 132 of the image film 130 can be produced. In another embodiment, the image film 130 may also be detachably located on the display region 152 by the electrostatic attraction theorem.

In the following description, the display back plate 110 having the electrophoretic display module will be used as an example, and the structure and the working status of the replaceable display system 100 will be described in detail.

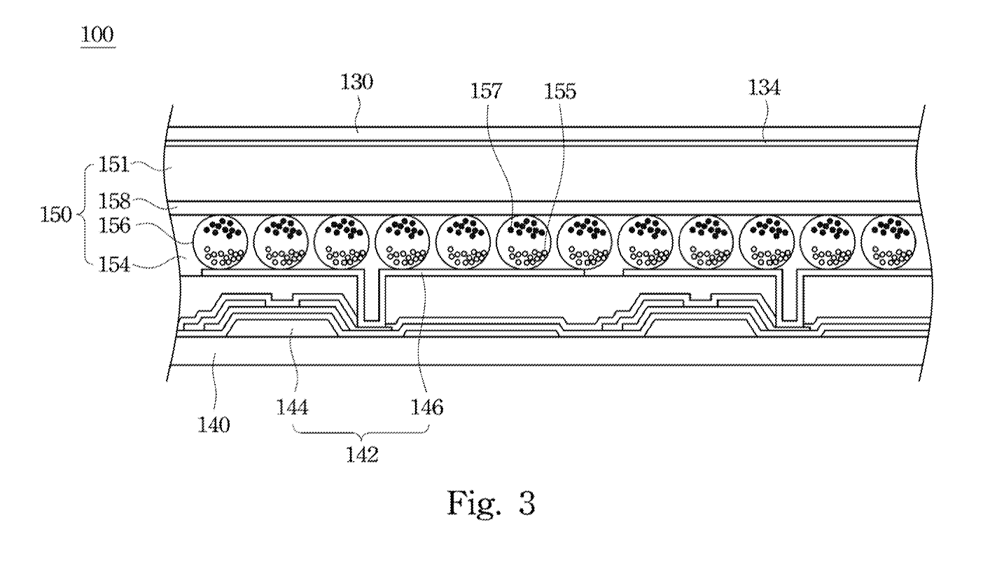

FIG. 3 is a cross-sectional view of the replaceable display system 100 taken along line 3-3′ shown in FIG. 1. As shown in FIG. 2 and FIG. 3, the driving array substrate 140 includes a plurality of pixel units 142. Each of the pixel units 142 includes a thin film transistor 144 and a pixel electrode 146. The front panel laminate 150 is located on the driving array substrate 140 and includes a transparent substrate 151, a display medium layer 154, and a common electrode 158. Each of the sub-display regions 153 is displayed as a bright face or a dark face by the display medium layer 154. Practically, the display medium layer 154 is sandwiched between the driving array substrate 140 and the transparent substrate 151, and includes a plurality of microencapsules 156. Each of the microencapsules 156 includes a plurality of bright electrophoretic particles 155 (e.g., white particles) and dark electrophoretic particles 157 (e.g., black particles). Furthermore, the common electrode 158 is located on the transparent substrate 151 and faces the pixel electrodes 146. The microencapsules 156 is located between the common electrode 158 and the pixel electrode 146.

In use, the controller 120 may changes electric fields formed between the common electrode 158 and each of the pixel electrodes 146, such that the bright electrophoretic particles 155 or the dark electrophoretic particles 157 are near upper side (i.e., a side adjacent to the image film 130). When the bright electrophoretic particles 155 are near upper side, and the dark electrophoretic particles 157 are near lower side (i.e., a side away from the image film 130), the sub-display regions 153 can reflect an incident light from the environment and so as to display as the bright face (e.g., white face). On the contrary, when the bright electrophoretic particles 155 are near lower side, and the dark electrophoretic particles 157 are near upper side, the sub-display regions 153 do not reflect an incident light from the environment and so as to display as the dark face (e.g., black face). Moreover, when a portion of the bright electrophoretic particles 155 and a portion of the dark electrophoretic particles 157 are near upper side, the sub-display regions 153 can display as a gray level.

As a result, each of the sub-display regions 153 can cover a portion of the display medium layer 154 and a portion of the pixel units 142. When the portion of the display medium layer 154 is driven by the under pixel units 142, the sub-display regions 153 above the portion of the display medium layer 154 can display as the bright face, the dark face, or the gray level. The controller 120 can control each of the sub-display regions 153 to independently display as the bright face, the dark face, or the gray level. Moreover, since the sub-display regions 153 are only as a back reflection face of the image film 130, the size of the pixel units 142 can be enlarged, and the number of the pixel units 142 can be reduced. That is to say, the display back plate 110 can have low resolution to save the manufacturing cost thereof.

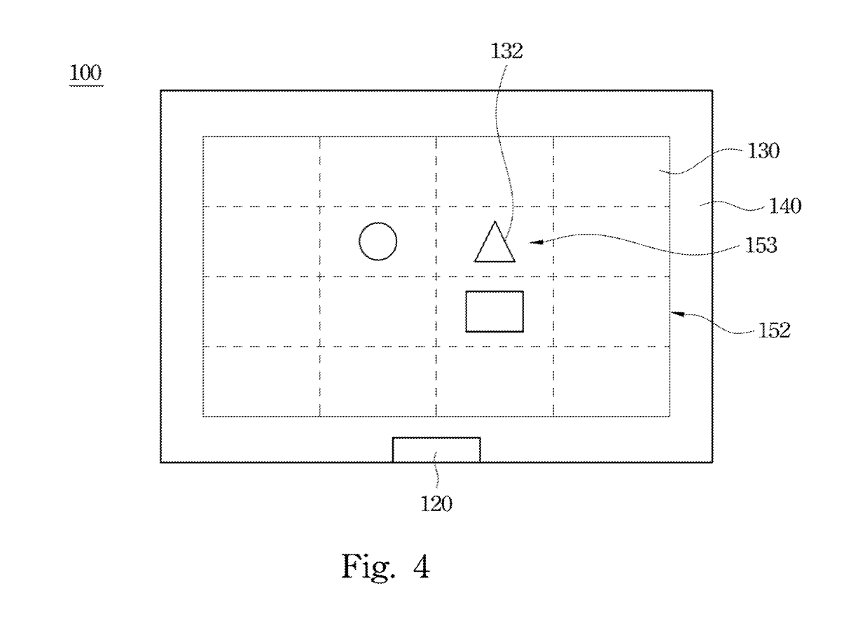

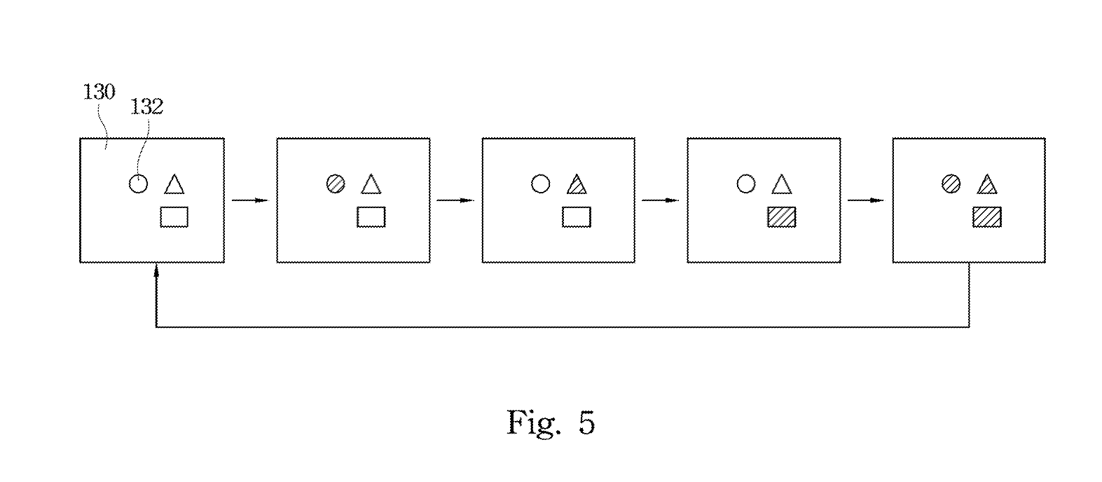

FIG. 4 is a front view of the replaceable display system 100 shown in FIG. 1. FIG. 5 is a schematic view of the light transmissive pattern portion 132 shown in FIG. 4 when displayed. As shown in FIG. 4 and FIG. 5, in this embodiment, the image film 130 has three the light transmissive pattern portions 132 with different shapes, such as circle, triangle, and rectangular, but not limited in this regard. The light transmissive pattern portions 132 may also be more complicated shapes, such as human images and totems. Each of the light transmissive pattern portions 132 is aligned with the single sub-display region 153. Therefore, the controller 120 only needs to control each of the three sub-display regions 153 under the three light transmissive pattern portions 132 to display the bright face or the dark face.

In FIG. 5, oblique line regions mean the light transmissive pattern portions 132 displayed as the bright faces. First, the controller 120 may control all the sub-display regions 153 to display as the dark faces by a software setting. Afterwards, the sub-display region 153 under the circle light transmissive pattern portion 132 is displayed as the bright face. Thereafter, the sub-display region 153 under the triangle light transmissive pattern portion 132 displays as the bright face, and the sub-display region 153 under the circle light transmissive pattern portion 132 displays as the dark face at the same time. Afterwards, the sub-display region 153 under the rectangular light transmissive pattern portion 132 displays as the bright face, and the sub-display region 153 under the triangle light transmissive pattern portion 132 displays as the dark face simultaneously. Thereafter, the sub-display regions 153 under the circle, triangle, and rectangular light transmissive pattern portions 132 display as the bright faces at the same time. Afterwards, all the sub-display regions 153 return to display as the dark faces at the same time. As a result, to go around and begin again, when one of the sub-display regions 153 covered by the image film 130 can display alternately dynamic variation as the bright face and the dark face, the pattern of the light-transmissive pattern portion 132 also correspondingly displays alternately bright and dark variation. When the replaceable display system 100 is applied to poster, thereby performing specific effect.

In this embodiment, shape of the sub-display regions 153 is rectangular, but not limited in this regard. In another embodiment, shapes of the sub-display regions 153 may also be rectangular, square, hexagonal, polygon, circular, or combinations thereof. The sub-display regions 153 are only as a back reflection face of the image film 130, and the size and number of the sub-display region 153 can be designed in accordance with the size of the light-transmissive pattern portion 132 of the image film 130.

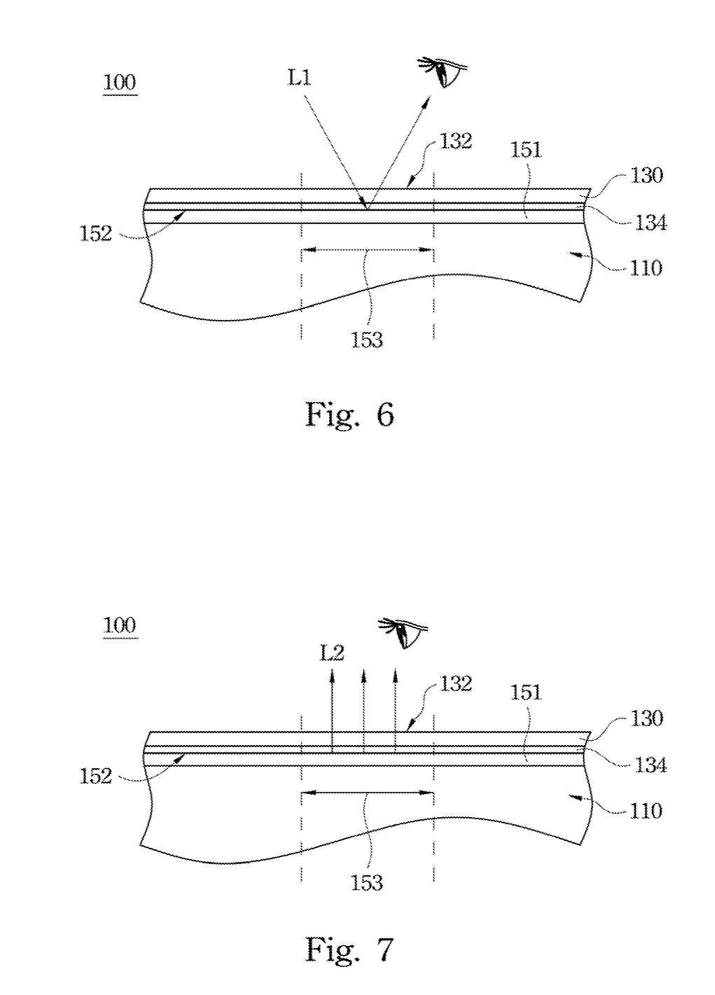

FIG. 6 is a cross-sectional view of the light transmissive pattern portion 132 shown in FIG. 4 when displayed. As shown in FIG. 2 and FIG. 6, when the display back plate 110 is a bi-stable display module, such as an electrophoretic display module or a cholesteric liquid crystal display module, and the sub-display region 153 displays as the bright face, an incident light L1 form the environment can be through the light-transmissive pattern portion 132 of the image film 130, afterwards, the incident light L1 is reflected by the sub-display region 153 displayed as the bright face. The reflected incident light L1 can be through outward the image film 130 and enter a human eye, such that the pattern of the light-transmissive pattern portion 132 is displayed.

Since the image film 130 is detachably located on the display region 152, and the light transmissive pattern portion 132 of the image film 130 is displayed by the sub-display regions 153 which display as the bright faces, the replaceable display system 100 can display different patterns by changing the image film 130 on the display region 152. That is to say, the display back plate 110 does not directly display an image, which is only as a back reflection face of the light transmissive pattern portion 132, such that a light is through the light transmissive pattern portion 132 to display the image. Therefore, the number of the sub-display regions 153 of the display back plate 110 and the number of the pixel units 142 of the driving array substrate 140 can be reduced, such that the display back plate 110 can have low resolution to save the manufacturing cost.

When another image film 130 including different light transmissive pattern portion 132 replaces the original image film 130, the sub-display regions 153 under the light transmissive pattern portion 132 can be displayed as the bright faces by the controller 120, such that the replaceable display system 100 displays a different pattern. Compared with a traditional poster, the replaceable display system 100 can display different patterns by the different image films 130. Furthermore, the image film 130 is not easily damaged when being detached, and which can be reused, thereby saving a waste of paper material and protecting the environment.

FIG. 7 is a schematic view of a light transmissive pattern 132 of a replaceable display system 100 when displayed according to an embodiment of the present invention. As shown in FIG. 2 and FIG. 7, when the display back plate 110 is a spontaneous light emitting display module, such as an organic light emitting diode display module or a light emitting diode display module, the sub-display region 153 can directly emit a light L2 so as to display as the bright face. The light L2 can be through outward the light-transmissive pattern portion 132 of the image film 130 and enter a human eye, such that the pattern of the light-transmissive pattern portion 132 is displayed. In this embodiment, the replaceable display system 100 also can display different patterns by changing the image film 130 on the display region 152. The display back plate 110 does not directly display an image, which is only as a back light source of the light transmissive pattern portion 132, such that the light L2 is through the light transmissive pattern portion 132 to display the pattern of the light transmissive pattern portion 132.

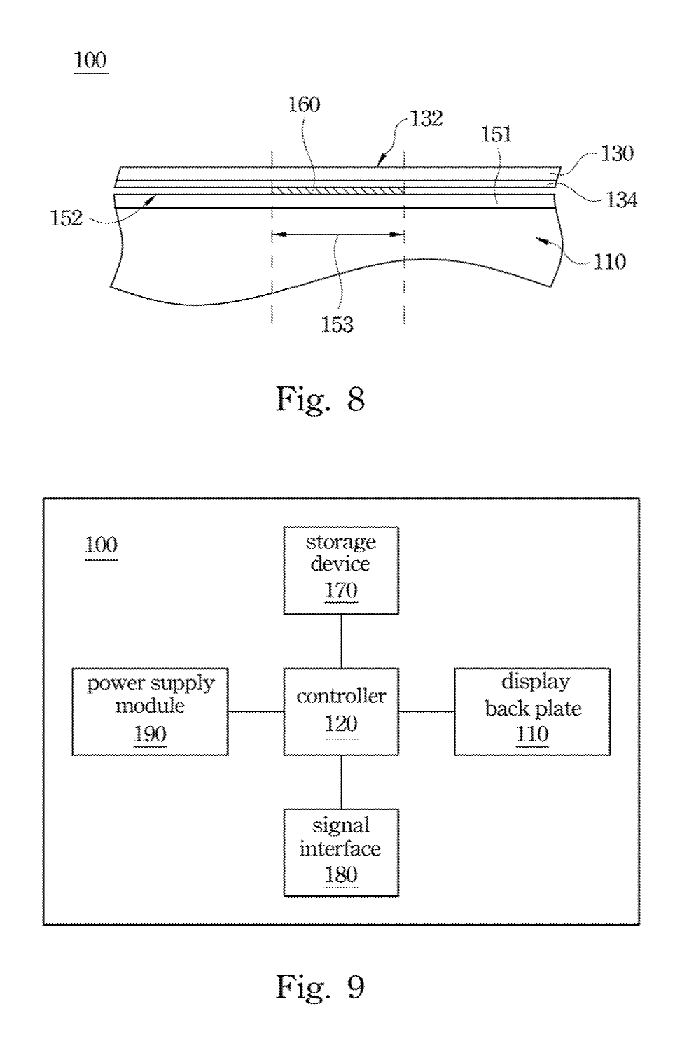

FIG. 8 is a schematic view of a replaceable display system 100 according to an embodiment of the present invention. The display back plate 110 is a spontaneous light emitting display module, such as an organic light emitting diode display module or a light emitting diode display module. The difference between this embodiment and FIG. 7 is that the replaceable display system 100 further includes a diffusion sheet 160. The diffusion sheet 160 is located between the image film 130 and the sub-display region 153 aligned with the light-transmissive pattern portion 132. As a result, a light emitted by the sub-display region 153 can diffuse by the diffusion sheet 160, such that the light through out the light-transmissive pattern portion 132 is more uniform, so as to display more clear pattern.

It is to be noted that the connection relationship of the aforementioned elements will not be repeated in the following description, and only aspects related to other elements of the replaceable display system 100 will be described.

FIG. 9 is a block diagram of a replaceable display system 100 according to an embodiment of the present invention. The replaceable display system 100 may further include a storage device 170, a signal interface 180, and a power supply module 190. The storage device 170, the signal interface 180, and the power supply module 190 are electrically connected to the controller 120. In the following descriptions, a driving program code means a program used to drive the sub-display region 153 (see FIG. 4) to display as the bright face or the dark face every time.

The storage device 170 can save the driving program code of the display back plate 110. The storage device 170 may be a memory card slot to be inserted by a memory card, or a built-in memory, such as a memory chip, a system-on-chip memory (SOC), or an embedded memory. The signal interface 180 may be a universal serial bus (USB) to receive an inputting control signal. The signal interface 180 can be inputted the driving program code from a notebook computer, a smart phone, or other portable devices. The controller 120 can read the driving program code of the storage device 170 or receive an input signal from the signal interface 180 to control the display back plate 110. The power supply module 190 can provide the display back plate 110 electricity, which may include a photoelectric conversion module, a battery, or a power interface. The photoelectric conversion module can be collocated with a solar panel having a specific wavelength in accordance with usage situations (e.g., indoor situation or outdoor situation).

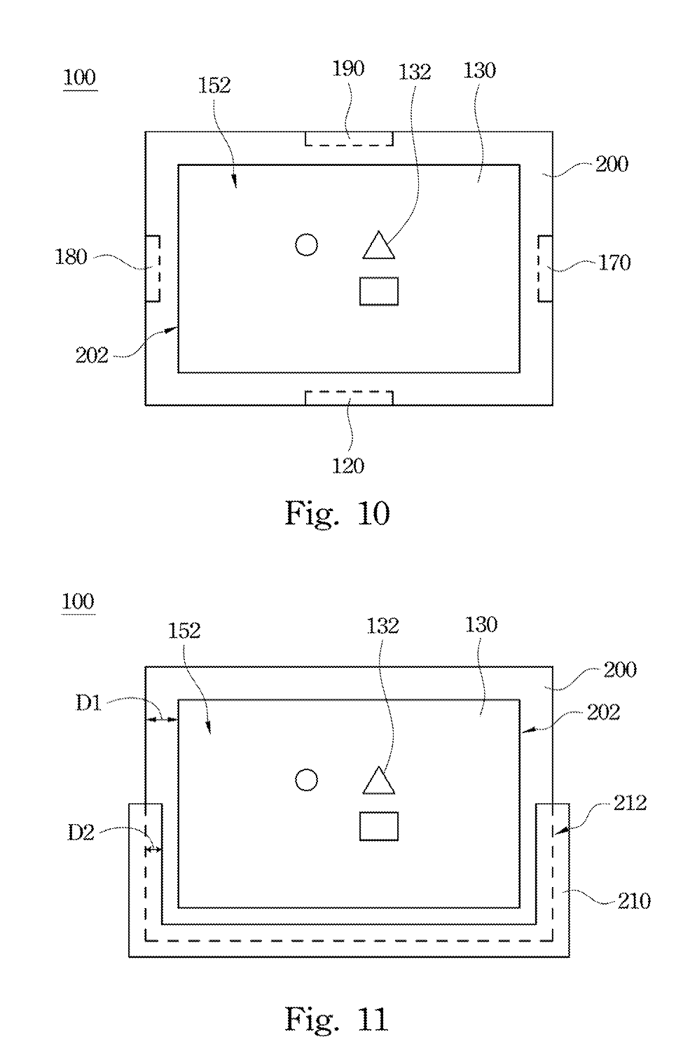

FIG. 10 is a front view of a replaceable display system 100 according to an embodiment of the present invention. The replaceable display system 100 further includes a housing case 200. The housing case 200 can accommodates the display back plate 110 (see FIG. 2) and the image film 130, and includes an opening 202 aligned with the display region 152. Moreover, the housing case 200 may also accommodate the controller 120, the storage device 170, the signal interface 180, and the power supply module 190. In this embodiment, the controller 120, the storage device 170, the signal interface 180, and the power supply module 190 are respectively located on four inner edges of the housing case 200, but not limited in this regard.

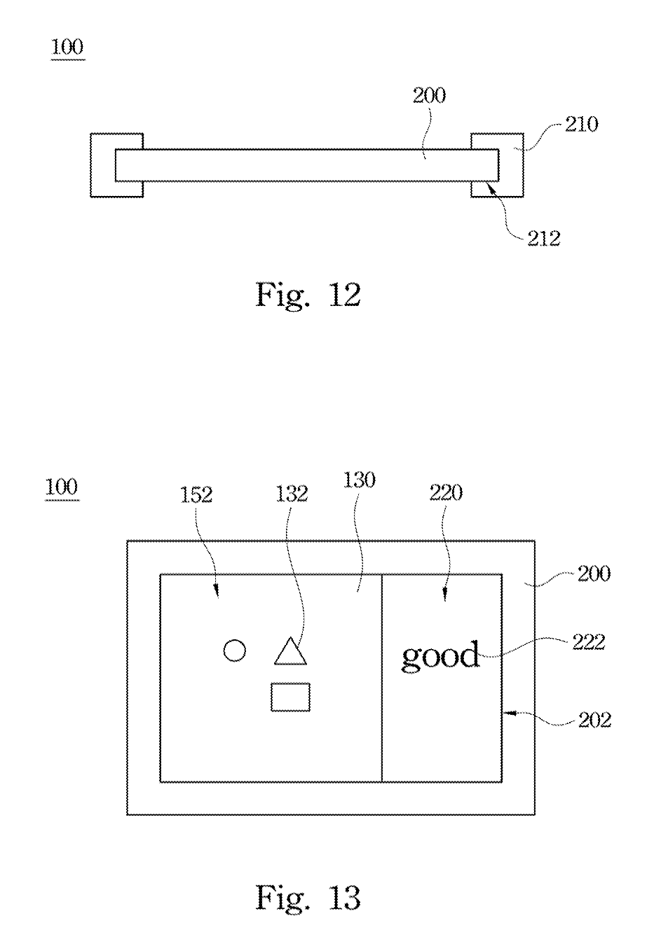

FIG. 11 is a front view of a replaceable display system 100 according to an embodiment of the present invention. FIG. 12 is a tap view of the replaceable display system 100 shown in FIG. 11. As shown in FIG. 11 and FIG. 12, the replaceable display system 100 may further include a stand 210. The stand 210 includes a groove 212 to couple to the housing case 200, such that the replaceable display system 100 can be exhibited and swapped. The housing case 200 surrounding the display region 152 has a width D1, and the groove 212 of the stand 210 has a depth D2. When the width D1 is larger than the depth D2, the display region 152 can prevent from scratching by the stand 210. Furthermore, the housing case 200 can further provide an enough space to accommodate the controller 120, the storage device 170, the signal interface 180, and the power supply module 190 shown in FIG. 10.

FIG. 13 is a front view of a replaceable display system 100 according to an embodiment of the present invention. In this embodiment, the display back plate 110 (see FIG. 2) further includes a non-image display region 220. The non-image display region 220 is adjacent to the display region 152 to display a text 222. Positions of the display region 152 and the non-image display region 220 and sizes of the display region 152 and the non-image display region 220 can be determined by the controller 120 (see FIG. 10) and the aforementioned driving program code.

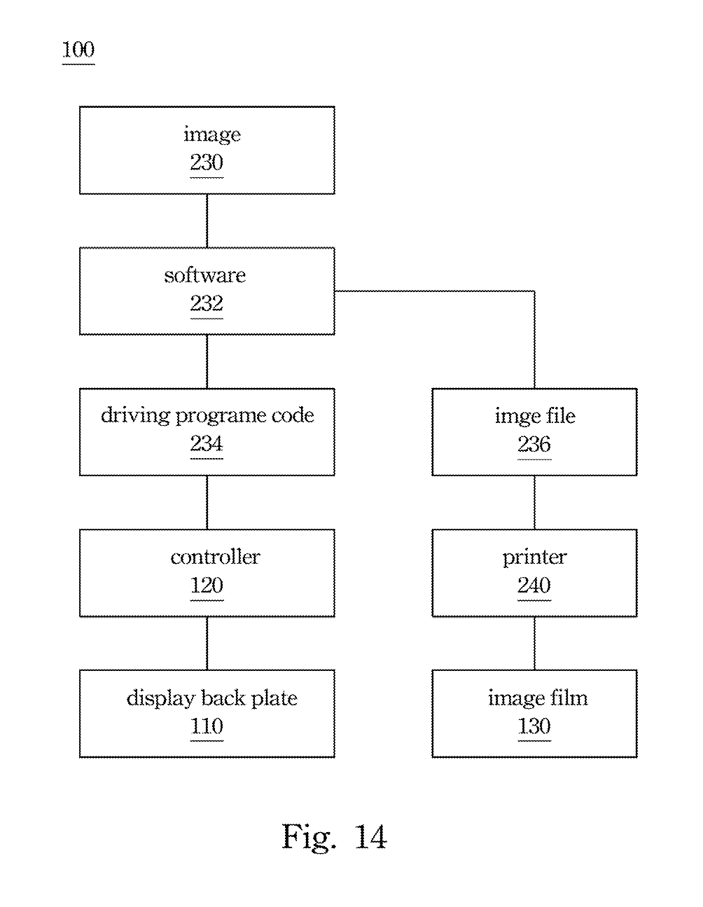

FIG. 14 is a block diagram of a replaceable display system 100 according to an embodiment of the present invention. The replaceable display system 100 may further include software 232. The software 232 has an editing template, and the editing template can be inputted an image 230 to edit. The software 232 can save an image file 236 after editing the image 230, and the image file 236 can be outputted to a printer 240 by the software 232. Afterwards, the printer 240 prints out the image file 130 having the light-transmissive pattern portion 132 (see FIG. 2). The image film 130 can be detachably located on the display region 152 of the display back plate 110 (see FIG. 2) by an adhering method or an electrostatic attraction method. The software 232 can produce a driving program code 234 collocated with the image file 236 at the same time. When the driving program code 234 is inputted to the controller 120, the display back plate 110 is driven to work, such that the sub-display region 153 (see FIG. 2) aligned with the light-transmissive pattern portion 132 (see FIG. 2) displays as the bright face, the dark face, or the gray level.

The reader's attention is directed to all papers and documents which are filed concurrently with this specification and which are open to public inspection with this specification, and the contents of all such papers and documents are incorporated herein by reference.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. A replaceable display system comprising:
a display back plate comprising:
a driving array substrate having a plurality of pixel units; and
a front panel laminate located on the driving array substrate and comprising a display region that has a plurality of sub-display regions, wherein at least two of the pixel units are completely present in an orthogonal projection of one of the sub-display regions on the driving array substrate;
a controller electrically connected to the display back plate for controlling each of the sub-display regions to display as a bright face or a dark face; and
an image element detachably located on the display region and comprising:
a light-transmissive pattern portion completely present in an orthogonal projection of one of the sub-display regions on the image element.

2. The replaceable display system as claimed in claim 1, further comprising:
an adhesive layer located between the image element and the display region.

3. The replaceable display system as claimed in claim 2, wherein an adhesion force formed between the adhesive layer and the image element is larger than another adhesion force formed between the adhesive layer and the display region.

4. The replaceable display system as claimed in claim 1, wherein the front panel laminate comprising a transparent substrate and a display medium layer, and the display medium layer is sandwiched between the driving array substrate and the transparent substrate, and each of the sub-display regions is displayed as the bright face or the dark face by the display medium layer.

5. The replaceable display system s claimed in claim 4, wherein each of the pixel units comprises a thin film transistor and a pixel electrode; the display medium layer comprises a plurality of microencapsules; and the front panel laminate further comprises:
a common electrode located on the transparent substrate and facing the pixel electrodes, wherein the microencapsules are located between the common electrode and the pixel electrodes.

6. The replaceable display system as claimed in claim 5, wherein each of the microencapsules comprises a plurality of bright electrophoretic particles and dark electrophoretic particles for displaying one of the sub-display regions as the bright face or the dark face.

7. The replaceable display system as claimed in claim 1, wherein the display back plate comprises a bi-stable display module, wherein the bi-stable display module comprises an electrophoretic display module or a cholesteric liquid crystal display module.

8. The replaceable display system as claimed in claim 1, wherein the display back plate comprises a spontaneous light emitting display module, wherein the spontaneous light emitting display module comprises an organic light emitting diode display module or a light emitting diode display module.

9. The replaceable display system as claimed in claim 8, further comprising:
a diffusion sheet located between the image element and one of the sub-display regions which is aligned with the light-transmissive pattern portion.

10. The replaceable display system as claimed in claim 1 wherein, when one of the sub-display regions covered by the image element displays alternately dynamic variation as the bright face and the dark face, the pattern of the light-transmissive pattern portion correspondingly displays alternately bright and dark variation.

11. The replaceable display system as claimed in claim 1, wherein shapes of the sub-display regions comprise rectangular, square, hexagonal, polygon, circular, or combinations thereof.

12. The replaceable display system as claimed in claim 1, wherein the display back plate further comprises:
a non-image display region adjacent to the display region for displaying a text.

13. The replaceable display system as claimed in claim 1, further comprising:
a storage device electrically connected to the controller for saving a driving program code of the display back plate.

14. The replaceable display system as claimed in claim 13, wherein the storage device comprises a memory card slot, a memory chip, a system-on-chip memory, or an embedded memory.

15. The replaceable display system as claimed in claim 1, further comprising:
a signal interface electrically connected to the controller for receiving an inputting control signal.

16. The replaceable display system as claimed in claim 15, wherein the signal interface comprises a universal serial bus.

17. The replaceable display system as claimed in claim 1, further comprising:
a power supply module electrically connected to the controller for providing the display back plate electricity.

18. The replaceable display system as claimed in claim 17, wherein the power supply module comprises a photoelectric conversion module, a battery, or a power interface.

19. The replaceable display system as claimed in claim 1, further comprising:
a housing case accommodating the display back plate and the image element and comprising an opening aligned with the display region; and
a stand comprising a groove for coupling to the housing case.
